(19) United States
(12) Patent Application Publication
(10) Pub. No.: US 2025/0157332 A1
(43) Pub. Date: May 15, 2025

(54) APPARATUS AND METHOD FOR PROVIDING SAFETY INFORMATION

(71) Applicants: HYUNDAI MOTOR COMPANY, SEOUL (KR); KIA CORPORATION, SEOUL (KR)

(72) Inventor: Tae Heon Kim, Hwaseong-si (KR)

(73) Assignees: HYUNDAI MOTOR COMPANY, SEOUL (KR); KIA CORPORATION, SEOUL (KR)

(21) Appl. No.: 18/933,083

(22) Filed: Oct. 31, 2024

(30) Foreign Application Priority Data
Nov. 9, 2023 (KR) 10-2023-0154838

(51) Int. Cl. G08G 1/0967; G01C 21/34; G06V 10/94; G06V 20/52; G06V 20/54; G06V 40/10; G08G 1/01

(52) U.S. Cl. CPC G08G 1/096783; G01C 21/3461; G06V 10/95; G06V 20/53; G06V 20/54; G06V 40/10; G08G 1/0116; G06V 2201/08

(57) ABSTRACT

A system for providing safety information includes an analysis server that receives image data and traffic signal information from an external device, recognizes a pedestrian from the image data, and analyzes pedestrian safety associated with the recognition of the pedestrian in view of the traffic signal information, and a navigation server that generates and transmits pedestrian safety information to a vehicle terminal based on the analysis of the pedestrian safety, which is output from the analysis server.

### CROSS REFERENCE TO RELATED APPLICATIONS

This application claims the benefit of priority to Korean Patent Application No. 10-2023-0154838, filed in the Korean Intellectual Property Office on Nov. 9, 2023, the entire contents of which are incorporated herein by reference.

### TECHNICAL FIELD

The present disclosure relates to a system and a method for providing safety information.

### BACKGROUND

A navigation system may verify a current location of a vehicle using a global positioning system (GPS), may navigate a route from the current location to a destination and may guide a user to the destination along the navigated route.

When guiding the user to the destination, such a navigation system may provide real-time traffic information (e.g., a congestion section, a construction section, road blocking, or the like), a transportation handicapped protection zone (e.g., a sliver zone or a school zone), and traffic light display information (e.g., a remaining time for each signal) in the direction of progress of the vehicle.

### SUMMARY

The present disclosure has been made to solve the above-mentioned problems occurring in the prior art while advantages achieved by the prior art are maintained intact.

An aspect of the present disclosure provides a system and a method for providing safety information to provide pedestrian safety information by means of pedestrian recognition based on image data obtained by a vehicle and an infrastructure on a roadside.

Another aspect of the present disclosure provides a system and a method for providing safety information to link traffic signal information considering the direction of progress of a vehicle to provide pedestrian safety information.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a system for providing safety information may include an analysis server that receives image data and traffic signal information from an external device, recognize a pedestrian from the image data, and analyze pedestrian safety associated with the result of recognizing the pedestrian to the traffic signal information and a navigation server that generates and transmits pedestrian safety information to a vehicle terminal based on the result of analyzing the pedestrian safety being output from the analysis server.

The navigation server may collect forward image data of a vehicle being transmitted from the vehicle terminal, and may transmit the collected forward image data to the analysis server. The vehicle terminal may obtain the forward image data of the vehicle using a camera mounted on the vehicle.

The analysis server may receive image data obtained by means of an infrastructure installed on a roadside and may receive the traffic signal information from a traffic signal operating system.

The analysis server may determine whether there is a pedestrian in the image data using a pedestrian discrimination model.

The pedestrian discrimination model may be implemented as a histogram of oriented gradients (HOG) algorithm.

The analysis server may determine whether there is a need for pedestrian caution based on traffic signal information and whether there is a pedestrian at an intersection based on the direction of progress of a vehicle.

The analysis server may divide a time zone when vehicle traffic and pedestrian traffic conflict with each other based on the traffic signal information and may determine whether there is a need for pedestrian caution based on whether there is a pedestrian in image data collected in the divided time zone.

The navigation server may generate guidance information for providing guidance on vehicle behavior control for the pedestrian safety based on the result of analyzing the pedestrian safety and may transmit the generated guidance information to the vehicle terminal.

The navigation server may generate a route for reaching a destination from a starting point depending on a route navigation request transmitted from the vehicle terminal, may obtain traffic signal information in the route, and may transmit the route in conjunction with the traffic signal information in the route to the vehicle terminal.

The vehicle terminal may transmit the pedestrian safety information to an output device.

According to another aspect of the present disclosure, a method for providing safety information may include receiving, by an analysis server, image data and traffic signal information from an external device, recognizing, by the analysis server, a pedestrian from the image data, analyzing, by the analysis server, pedestrian safety associated with the result of recognizing the pedestrian to the traffic signal information, transmitting, by the analysis server, the result of analyzing the pedestrian safety to a navigation server, and transmitting, by the navigation server, pedestrian safety information to a vehicle terminal based on the result of analyzing the pedestrian safety.

The receiving of the image data and the traffic signal information may include transmitting, by the vehicle terminal, forward image data of a vehicle being obtained by a camera mounted on the vehicle, to the navigation server and receiving and transmitting, by the navigation server, the forward image data of the vehicle to the analysis server.

The receiving of the image data and the traffic signal information may include receiving, by the analysis server, the image data obtained by an infrastructure installed on a roadside and receiving, by the analysis server, the traffic signal information from a traffic signal operating system.

The recognizing of the pedestrian may include determining, by the analysis server, whether there is a pedestrian in the image data using a pedestrian discrimination model.

The analyzing of pedestrian safety may include determining, by the analysis server, whether there is a need for pedestrian caution based on traffic signal information and whether there is a pedestrian at an intersection based on the direction of progress of a vehicle.

The analyzing of pedestrian safety may include dividing, by the analysis server, a time zone when vehicle traffic and pedestrian traffic conflict with each other based on the traffic signal information and determining, by the analysis server, whether there is a need for pedestrian caution based on whether there is a pedestrian in image data collected in the divided time zone.

The transmitting of the pedestrian safety information may include generating, by the navigation server, guidance information for providing guidance on vehicle behavior control for the pedestrian safety based on the result of analyzing the pedestrian safety and transmitting, by the navigation server, the generated guidance information to the vehicle terminal.

The method may further include generating, by the navigation server, a route for reaching a destination from a starting point depending on a route navigation request transmitted from the vehicle terminal, obtaining, by the navigation server, traffic signal information in the route, and transmitting, by the navigation server, the route in conjunction with the traffic signal information in the route to the vehicle terminal.

The method may further include outputting, by the vehicle terminal, the pedestrian safety information to an output device.

### BRIEF DESCRIPTION OF THE FIGURES

The above and other objects, features and advantages of the present disclosure will be more apparent from the following detailed description taken in conjunction with the accompanying drawings:

FIG. 1 is a block diagram illustrating a configuration of a system for providing safety information according to embodiments of the present disclosure;

FIG. 2 is a block diagram illustrating a configuration of a vehicle terminal illustrated in FIG. 1;

FIG. 3 is a block diagram illustrating a configuration of a traffic control server illustrated in FIG. 1;

FIG. 4 is a drawing for describing an operation of a system for providing safety information according to embodiments of the present disclosure;

FIG. 5 is a drawing for describing an example of providing safety information according to embodiments of the present disclosure;

FIG. 6 is a flowchart illustrating a method for providing safety information according to embodiments of the present disclosure; and

FIG. 7 is a block diagram illustrating a computing system for executing a method for providing safety information according to embodiments of the present disclosure.

### DETAILED DESCRIPTION

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

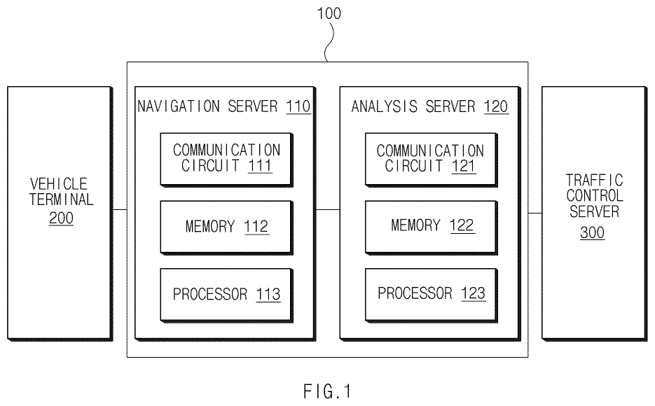

FIG. 1 is a block diagram illustrating a configuration of a system for providing safety information according to embodiments of the present disclosure.

A system 100 for providing safety information may include a navigation server 110 and an analysis server 120, which are connected over a network. The network may be implemented as a wired network, such as a local area network (LAN), a wide area network (WAN), an Ethernet, and/or an integrated services digital network (ISDN), and/or a wireless network, such as a wireless LAN (WLAN) (Wi-Fi), wireless broadband (Wibro), world interoperability for microwave access (WiMAX), and/or fifth generation technology standard (5G) network.

The navigation server 110 may provide a vehicle terminal 200 with a route and pedestrian safety information. The navigation server 110 may include a communication circuit 111, a memory 112, and a processor 113.

The communication circuit 111 may support the navigation server 110 to communicate with the analysis server 120 and/or the vehicle terminal 200. The communication circuit 111 may include a wireless communication circuit (e.g., a mobile communication circuit, a short range wireless communication circuit, or a global navigation satellite system (GNSS) communication circuit) for supporting to transmit and receive data over the wireless network and a wired communication circuit (e.g., a LAN communication circuit or a power line communication circuit) for supporting to transmit and receive data over the wired network.

The memory 112 may store map data. Furthermore, the memory 112 may store data received through the communication circuit 111.

The memory 112 may be a non-transitory storage medium which stores instructions executed by the processor 113. The memory 112 may include a flash memory, a hard disk, a solid state disk (SSD), a secure digital (SD) card, a random access memory (RAM), a static RAM (SRAM), a read only memory (ROM), a programmable ROM (PROM), an electrically erasable and programmable ROM (EEPROM), an erasable and programmable ROM (EPROM), or the like.

The processor 113 may control the overall operation of the navigation server 110. The processor 113 may be implemented as at least one of processing devices such as an application specific integrated circuit (ASIC), a digital signal processor (DSP), a programmable logic device (PLD), a field programmable gate array (FPGA), a central processing unit (CPU), a microcontroller, or a microprocessor.

The processor 113 may receive a route navigation request transmitted from the vehicle terminal 200 through the communication circuit 111. The processor 113 may navigate (or generate) a route (or a driving route) for reaching a destination from a starting point (e.g., a current location of a vehicle, a location specified by a user, or the like) based on starting point information and destination (or arrival point) information included in the route navigation request.

The processor 113 may generate a route using the map data stored in the memory 112. The processor 113 may reflect real-time traffic information to generate a route. The processor 113 may transmit the generated route to the vehicle terminal 200 using the communication circuit 111.

When generating the route, the processor 113 may interwork with a traffic signal operating system to obtain traffic signal information in the generated route. The processor 113 may transmit the obtained traffic signal information together with the generated route to the vehicle terminal 200. The traffic signal information may include vehicle signal information indicating whether vehicle traffic is permitted and pedestrian signal information indicating whether pedestrian traffic is permitted.

The processor 113 may receive forward image data of a vehicle, which is transmitted from the vehicle terminal 200, using the communication circuit 111. The processor 113 may transmit the received forward image data of the vehicle to the analysis server 120. It is described for helping the understanding of the present disclosure in the present embodiment that the navigation server 110 receives the forward image data of the vehicle from the one vehicle terminal 200, but not limited thereto. The navigation server 110 may receive forward image data of each of at least two vehicles from at least two vehicle terminals, that is, the at least two vehicles.

The processor 113 may receive the result of analyzing pedestrian safety, which is transmitted from the analysis server 120, through the communication circuit 111. The processor 113 may generate pedestrian safety information (or pedestrian caution information) based on the received result of analyzing the pedestrian safety. The processor 113 may transmit the generated pedestrian safety information to the vehicle terminal 200 using the communication circuit 111. The pedestrian safety information may include vehicle behavior control information (e.g., pausing, slowing down, or the like) for pedestrian safety based on the Road Traffic Law or the like.

The analysis server 120 may perform a pedestrian safety analysis based on image data and traffic signal information at an intersection the vehicle approaches. Such an analysis server 120 may include a communication circuit 121, a memory 122, and a processor 123.

The communication circuit 121 may support the analysis server 120 to communicate with the navigation server 110 and/or a traffic control server 300. The communication circuit 121 may include a wireless communication circuit, a wired communication circuit, and/or the like. The communication circuit 121 may receive forward image data (or first image data) transmitted from the navigation server 110. Furthermore, the communication circuit 121 may receive image data (or second image data) and traffic signal information transmitted from the traffic control server 300.

The memory 122 may store the first image data, the second image data, and the traffic signal information received through the communication circuit 121. The memory 122 may store a pedestrian discrimination model (or a pedestrian recognition model). The pedestrian discrimination model may be implemented as a histogram of oriented gradients (HOG) algorithm.

The memory 122 may be a non-transitory storage medium which stores instructions executed by the processor 123. The memory 122 may include at least one of storage media such as a flash memory, a hard disk, an SSD, a RAM, an SRAM, a ROM, a PROM, an EEPROM, or an EPROM.

The processor 123 may control the overall operation of the analysis server 120. The processor 123 may be implemented as at least one of processing devices such as an ASIC, a DSP, a PLD, an FPGA, a CPU, a microcontroller, or a microprocessor.

The processor 123 may collect image data transmitted from an external device (e.g., the navigation server 110, the traffic control server 300, and/or the like) using the communication circuit 121. As an example, the processor 123 may classify an image for each intersection to collect image data. As another example, the processor 123 may interwork with the traffic control server 300 to divide a time zone when vehicle traffic and pedestrian traffic conflict with each other based on traffic signal information at an intersection. The processor 123 may collect image data in the divided time zone.

The processor 123 may identify (or recognize) a pedestrian from the collected image data using the pedestrian discrimination model. When receiving image data, the pedestrian discrimination model may output pedestrian information including whether there is a pedestrian, a position of the pedestrian, and/or the like by means of pedestrian recognition in the image data.

The processor 123 may perform a pedestrian safety analysis based on the traffic signal information and the pedestrian information. When the pedestrian safety analysis is completed, the processor 123 may transmit the analyzed result to the navigation server 110. The pedestrian safety analysis may be used to determine whether there is a need for caution for pedestrian safety.

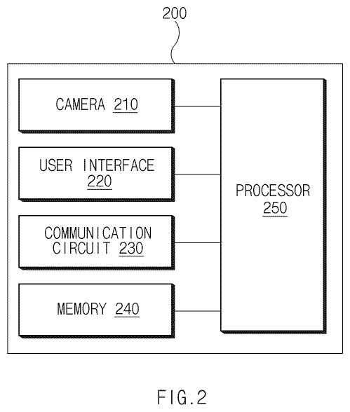

FIG. 2 is a block diagram illustrating a configuration of a vehicle terminal illustrated in FIG. 1.

A vehicle terminal 200 may be a device mounted on a vehicle, which may be an audio, video, navigation (AVN) terminal, an in-vehicle infotainment terminal, a telematics terminal, or the like. Such a vehicle terminal 200 may include a camera 210, a user interface 220, a communication circuit 230, a memory 240, and a processor 250.

The camera 210 may be mounted on the vehicle to capture the front and/or periphery (e.g., the side or the rear) of the vehicle. The camera 210 may store the captured image data, for example, forward image data of the vehicle in the memory 240. Furthermore, the camera 210 may directly transmit the captured image data to the processor 250.

The user interface 220 may be a device which helps the vehicle terminal 200 and a user to interact with each other. The user interface 220 may include an input device (e.g., a keyboard, a touch pad, a microphone, a touch screen, and/or the like) for generating data according to manipulation of the user, an output device (e.g., a display, a speaker, a tactile signal output device, and/or the like) for outputting information according to an operation of a vehicle system, and/or the like.

The communication circuit 230 may perform communication between the vehicle terminal 200 and a navigation server 110. The communication circuit 230 may include a wireless communication circuit and/or a wired communication circuit.

The memory 240 may be a non-transitory storage medium which stores instructions executed by the processor 250. The memory 240 may include at least one of storage media such as a flash memory, a hard disk, an SSD, a RAM, an SRAM, a ROM, a PROM, an EEPROM, or an EPROM.

The processor 250 may control the overall operation of the vehicle terminal 200. The processor 250 may be implemented as at least one of processing devices such as an ASIC, a DSP, a PLD, an FPGA, a CPU, a microcontroller, or a microprocessor.

The processor 250 may generate starting point information and destination information based on input data received from the user interface 220. The processor 250 may generate a route navigation request using the generated starting point information and the generated destination information. The processor 250 may transmit the generated route navigation request to the navigation server 110 using the communication circuit 230.

The processor 250 may transmit the forward image data of the vehicle, which is obtained using the camera 210, to the navigation server 110. When there is an intersection in the front of the vehicle, the processor 250 may obtain the forward image data of the vehicle using the camera 210.

The processor 250 may receive route information transmitted from the navigation server 110. The processor 250 may output route guidance information to the user interface 220 depending on the received route.

The processor 250 may receive pedestrian safety information transmitted from the navigation server 110. The processor 250 may output the received pedestrian safety information to the user interface 220. The processor 250 may output the pedestrian safety information as a signal in the form of being recognized using sight, hearing, and/or the like by a user to the user interface 220.

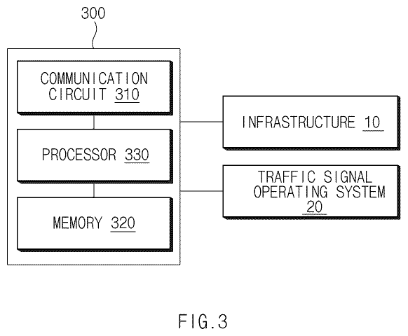

FIG. 3 is a block diagram illustrating a configuration of a traffic control server illustrated in FIG. 1.

A traffic control server 300 may include a communication circuit 310, a memory 320, and a processor 330.

The communication circuit 310 may support the traffic control server 300 to communicate with an external device, for example, an analysis server 120, an infrastructure 10, a traffic signal operating system 20, and/or the like. The communication circuit 310 may include a wireless communication circuit and/or a wired communication circuit.

The memory 320 may store data received through the communication circuit 310. The memory 320 may be a non-transitory storage medium which stores instructions executed by the processor 330. The memory 320 may include at least one of storage media such as a flash memory, a hard disk, an SSD, a RAM, an SRAM, a ROM, a PROM, an EEPROM, or an EPROM.

The processor 330 may control the overall operation of the traffic control server 300. The processor 330 may be implemented as at least one of processing devices such as an ASIC, a DSP, a PLD, an FPGA, a CPU, a microcontroller, or a microprocessor.

The processor 330 may receive image data transmitted from the infrastructure 10 using the communication circuit 310. The infrastructure 10 may be installed on a roadside to obtain image data around a road using a camera (or an image sensor). The infrastructure 10 may be a closed circuit television (CCTV), a traffic information collection device, or the like.

The processor 330 may receive traffic signal information from the traffic signal operating system 20 using the communication circuit 310. The traffic signal information may include traffic light identification information, signal display information, a traffic light installation position, and/or the like.

The processor 330 may collect traffic information (e.g., a congestion section, a construction section, and/or the like) using sensors installed in the road and may collect traffic information using sensors mounted on vehicles.

The processor 330 may transmit the collected image data, the traffic signal information, the traffic information, and/or the like to the analysis server 120.

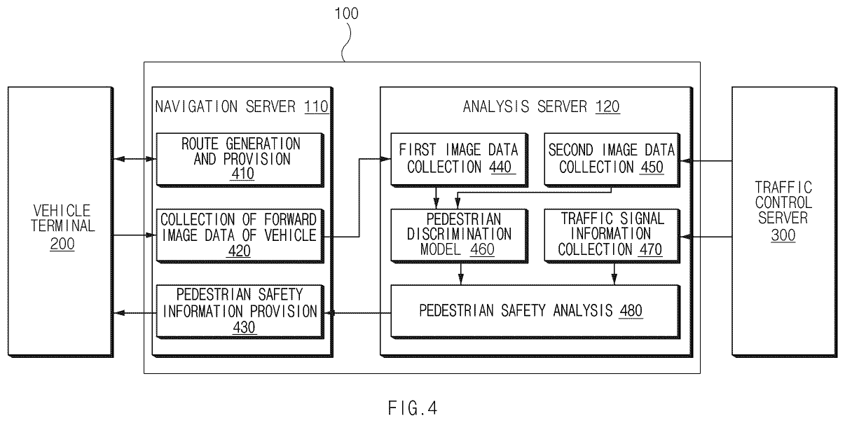

FIG. 4 is a drawing for describing an operation of a system for providing safety information according to embodiments of the present disclosure.

A navigation server 110 may perform route generation and provision 410, collection 420 of forward image data of a vehicle, and pedestrian safety information provision 430. An analysis server 120 may perform first image collection 440, second image data collection 450, a pedestrian discrimination model 460, traffic signal information collection 470, and a pedestrian safety analysis 480.

The navigation server 110 may receive a route navigation request from a vehicle terminal 200. The navigation server 110 may generate a route (or a driving route) for reaching a destination from a starting point (e.g., a current location of a vehicle, a location specified by a user, or the like) based on starting point information and destination information included in the received route navigation request. When generating a route, the navigation server 110 may generate the route using previously stored map data. Furthermore, the navigation server 110 may obtain real-time traffic information through a traffic control server 300 and may reflect the obtained real-time traffic information to generate a route. The navigation server 110 may transmit the generated route to the vehicle terminal 200.

When providing the route to the vehicle terminal 200, the navigation server 110 may link traffic signal information in the generated route to the generated route to provide the route to the vehicle terminal 200. In other words, the navigation server 110 may transmit the generated route information and the traffic signal information in the generated route together to the vehicle terminal 200.

The navigation server 110 may collect forward image data of the vehicle. The vehicle terminal 200 may obtain forward image data of the vehicle using a camera 210 mounted on the vehicle and may transmit the obtained forward image data of the vehicle to the navigation server 110. The navigation server 110 may receive the forward image data of the vehicle, which is transmitted from the vehicle terminal 200. The navigation server 110 may transmit the collected forward image data of the vehicle to the analysis server 120.

The analysis server 120 may collect image data from an external device (e.g., the vehicle terminal 200, the traffic control server 300, a traffic signal operating system 20, and/or the like). The analysis server 120 may receive the forward image data of the vehicle, which is transmitted from the navigation server 110. The analysis server 120 may classify and collect the received forward image data for each intersection. In other words, the analysis server 120 may collect image data for each intersection, which is obtained by the camera 210 mounted on the vehicle, that is, first image data.

Furthermore, the analysis server 120 may collect roadside image data, that is, second image data, by means of an infrastructure 10 installed on the roadside using the traffic control server 300. The traffic control server 300 may be provided in a police department, a municipality, a signal operation center, and/or the like and may provide traffic information, surrounding infrastructure information (e.g., CCTV image data), and the like.

The analysis server 120 may extract pedestrian information from the collected image data, that is, the first image data and the second image data. The analysis server 120 may identify (or recognize) a pedestrian in the image data using the pedestrian discrimination model 460. The pedestrian discrimination model 460 may determine whether there is a pedestrian by means of pedestrian recognition in the received image data.

The analysis server 120 may collect traffic signal information using the traffic control server 300. The analysis server 120 may analyze pedestrian safety based on the traffic signal information received from the traffic control server 300 and whether there is a pedestrian, which is output from the pedestrian discrimination model 460.

The analysis server 120 may determine a time zone when vehicle traffic and pedestrian traffic conflict with each other for each intersection based on the traffic signal information received from the traffic control server 300. The analysis server 120 may determine whether there is a pedestrian passing through a crosswalk on the intersection in the determined time zone. When it is determined that there is the pedestrian passing through the crosswalk on the intersection in the time zone when the vehicle traffic and the pedestrian traffic conflict with each other, the analysis server 120 may determine that there is a need for pedestrian caution.

The analysis server 120 may transmit the result of analyzing the pedestrian safety to the navigation server 110. The navigation server 110 may receive the result of analyzing the pedestrian safety, which is transmitted from the analysis server 120. The navigation server 110 may generate pedestrian safety information (or pedestrian caution information) based on the received result of analyzing the pedestrian safety and may transmit the generated pedestrian safety information to the vehicle terminal 200.

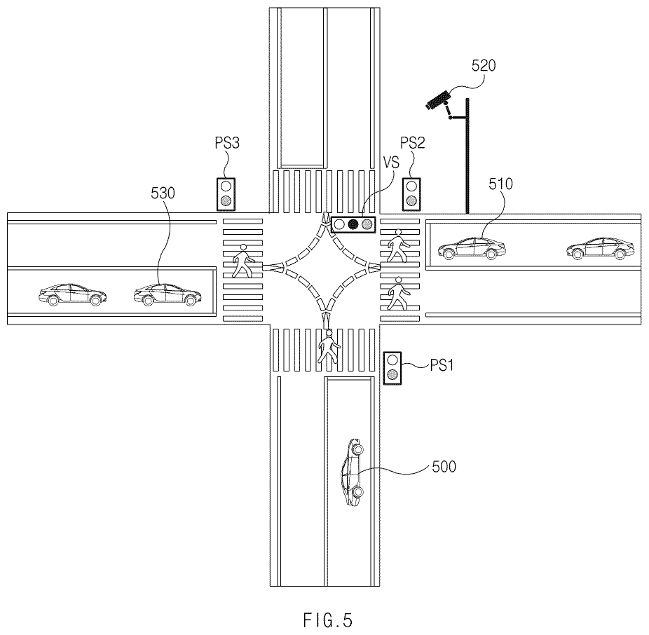

FIG. 5 is a drawing for describing an example of providing safety information according to embodiments of the present disclosure.

Referring to FIG. 5, there is a situation in which a vehicle 500 approaches an intersection. The vehicle 500 may go straight, may turn left, or may turn right, depending on route guidance. A system 100 for providing safety information may generate pedestrian safety information based on traffic signal information and whether there is a pedestrian who crosses a road and may provide (or transmit) the generated pedestrian safety information to the vehicle 500.

As an example, when the vehicle 500 turns right at the intersection, the system 100 for providing the safety information may collect forward image data of the vehicle 500 and forward image data of another vehicle 510. The system 100 for providing the safety information may collect image data captured by a CCTV 520 installed on a roadside.

The system 100 for providing the safety information may recognize a pedestrian from the image data using a histogram of oriented gradients (HOG) algorithm or the like. The system 100 for providing the safety information may determine whether there is a pedestrian by means of pedestrian recognition. At this time, the system 100 for providing the safety information may extract pedestrian information, such as the number of recognized pedestrians and a position for each recognized pedestrian, from the image data.

The system 100 for providing the safety information may verify signal display information of traffic signal information, that is, vehicle signal information and pedestrian signal information with regard to the direction of progress of the vehicle at the intersection. The system 100 for providing the safety information may determine whether there is a need for pedestrian caution with regard to a forward vehicle signal VS of the vehicle 500, a forward pedestrian signal PS1 of the vehicle 500, a pedestrian signal PS2 immediately after turning right, and whether there is a pedestrian. The system 100 for providing the safety information may generate safety information, such as Table 1 below, based on the forward vehicle signal VS of the vehicle 500, the forward pedestrian signal PS1 of the vehicle 500, the pedestrian signal PS2 immediately after turning right, and whether there is a pedestrian.

TABLE 1

| | | Access road | Right turn | | |
|---|---|---|---|---|---|
| | Access road | pedestrian | pedestrian | Whether there is | Safety |
| Scenario | vehicle signal | signal | signal | pedestrian | information |
| 1 | Red | Red | Red | ◯ | Pausing |
| | | | | X | Slowing down |
| | | | | Unidentified | Pausing |
| 2 | Red | Green | Red | No matter | Pausing |
| 3 | Red | Green | Green | No matter | Pausing |
| 4 | Green | Red | Red | ◯ | Pausing |
| | | | | X | Slowing down |
| | | | | Unidentified | Slowing down |
| 5 | Green | Red | Green | ◯ | Pausing |
| | | | | X | Slowing down |
| | | | | Unidentified | Pausing |

As another example, when the vehicle 500 turns left at the intersection, the system 100 for providing the safety information may analyze the forward image data collected through the vehicle 500 and another vehicle 530 to determine whether there is a pedestrian. The system 100 for providing the safety information may verify the forward vehicle signal VS of the vehicle 500, the forward pedestrian signal PS1 of the vehicle 500, and a pedestrian signal PS3 immediately after turning left. The system 100 for providing the safety information may generate safety information based on the forward vehicle signal VS of the vehicle 500, the forward pedestrian signal PS1 of the vehicle 500, the pedestrian signal PS3 immediately after turning left, and whether there is a pedestrian. The system 100 for providing the safety information may transmit the generated safety information to the vehicle 500. The vehicle 500 may receive the safety information transmitted from the system 100 for providing the safety information and may output the received safety information as a visual signal, an audible signal, and/or the like.

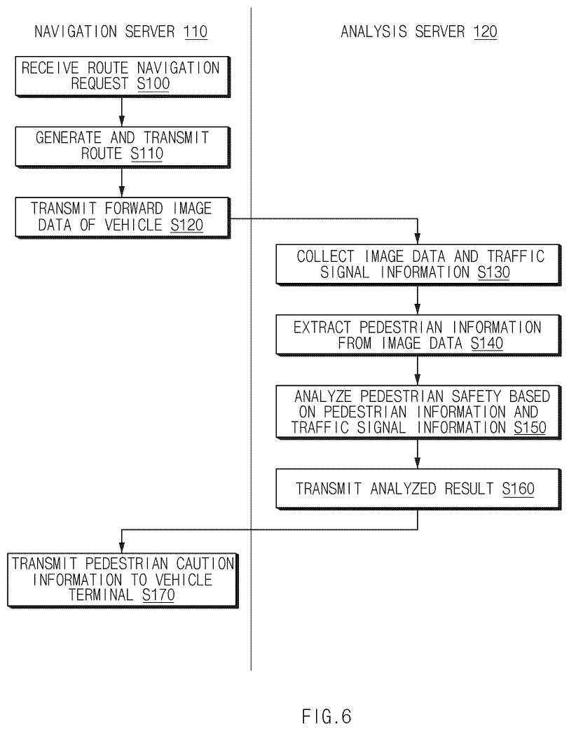

FIG. 6 is a flowchart illustrating a method for providing safety information according to embodiments of the present disclosure.

In S100, a navigation server 110 may receive a route navigation request transmitted from a vehicle terminal 200. The vehicle terminal 200 may transmit the route navigation request including starting point information and destination information of a vehicle to the navigation server 110.

In S110, the navigation server 110 may generate a route from a starting point to a destination depending on the received route navigation request and may transmit the generated route. The navigation server 110 may generate a route for reaching the destination from the starting point based on the starting point information and the destination information included in the received route navigation request. When generating the route, the navigation server 110 may generate the route using previously stored map data. Furthermore, the navigation server 110 may obtain real-time traffic information through a traffic control server 300 and may reflect the obtained real-time traffic information to generate a route. The navigation server 110 may transmit the generated route to the vehicle terminal 200. When providing the route to the vehicle terminal 200, the navigation server 110 may link traffic signal information in the generated route to the generated route to provide the route to the vehicle terminal 200. In other words, the navigation server 110 may transmit the generated route information and the traffic signal information in the generated route together to the vehicle terminal 200.

In S120, the navigation server 110 may transmit forward image data collected by means of the vehicle to an analysis server 120. The vehicle terminal 200 may obtain forward image data of the vehicle using a camera 210 mounted on the vehicle and may transmit the obtained forward image data of the vehicle to the navigation server 110. The navigation server 110 may receive the forward image data of the vehicle, which is transmitted from the vehicle terminal 200. The navigation server 110 may transmit the collected forward image data of the vehicle to the analysis server 120.

In S130, the analysis server 120 may collect image data and traffic signal information from an external device (e.g., the vehicle terminal 200, the traffic control server 300, and/or the like). The analysis server 120 may receive the forward image data of the vehicle, which is transmitted from the navigation server 110. The analysis server 120 may classify and collect the received forward image data for each intersection. The analysis server 120 may collect image data and traffic signal information using the traffic control server 300. The traffic control server 300 may obtain roadside image data by means of an infrastructure 10 installed on a roadside and may transmit the obtained roadside image data to the analysis server 120. The traffic control server 300 may interwork with a traffic signal operating system 20 to obtain traffic signal information and may transmit the obtained traffic signal information to the analysis server 120.

In S140, the analysis server 120 may extract pedestrian information from the collected image data. The analysis server 120 may identify (or recognize) a pedestrian in the image data using a pedestrian discrimination model 460. The pedestrian discrimination model 460 may determine whether there is a pedestrian by means of pedestrian recognition in the received image data.

In S150, the analysis server 120 may analyze pedestrian safety based on the pedestrian information and the traffic signal information. The analysis server 120 may analyze pedestrian safety based on the traffic signal information received from the traffic control server 300 and whether there is a pedestrian, which is output from the pedestrian discrimination model 460. The analysis server 120 may determine a time zone when vehicle traffic and pedestrian traffic conflict with each other for each intersection based on the traffic signal information received from the traffic control server 300. The analysis server 120 may determine whether there is a pedestrian passing through a crosswalk on the intersection in the determined time zone. When it is determined that there is the pedestrian passing through the crosswalk on the intersection in the time zone when the vehicle traffic and the pedestrian traffic conflict with each other, the analysis server 120 may determine that there is a need for pedestrian caution.

In S160, the analysis server 120 may transmit the result of analyzing the pedestrian safety to the navigation server 110.

In S170, the navigation server 110 may generate pedestrian caution information (or pedestrian safety information) based on the received result of analyzing the pedestrian safety and may transmit the generated pedestrian safety information to the vehicle terminal 200.

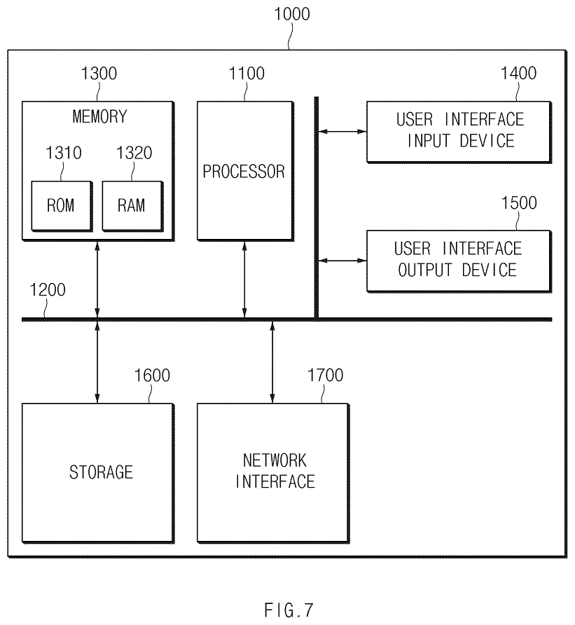

FIG. 7 is a block diagram illustrating a computing system for executing a method for providing safety information according to embodiments of the present disclosure.

Referring to FIG. 7, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

Embodiments of the present disclosure may recognize a pedestrian using image data obtained by a vehicle and an infrastructure on a roadside and may link the result of recognizing the pedestrian to traffic signal information considering the direction of progress of the vehicle to provide pedestrian safety information, thus preventing a traffic accident and ensuring the safety of the driver and the pedestrian.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

1. A system for providing safety information, the system comprising:
an analysis server configured to:
receive image data and traffic signal information from an external device;
recognize a pedestrian from the image data; and
analyze pedestrian safety associated with the recognition of the pedestrian in view of the traffic signal information; and
a navigation server configured to generate and transmit pedestrian safety information to a vehicle terminal based on the analysis of the pedestrian safety the pedestrian safety information being output from the analysis server.

2. The system of claim 1, wherein the navigation server is configured to:
collect forward image data of a vehicle being transmitted from the vehicle terminal; and
transmit the collected forward image data to the analysis server;
wherein the vehicle terminal is configured to obtain the forward image data of the vehicle using a camera mounted on the vehicle.

3. The system of claim 1, wherein the analysis server is configured to:
receive image data obtained by an infrastructure installed on a roadside; and
receive the traffic signal information from a traffic signal operating system.

4. The system of claim 1, wherein the analysis server is configured to determine whether there is a pedestrian in the image data using a pedestrian discrimination model.

5. The system of claim 4, wherein the pedestrian discrimination model is a histogram of oriented gradients (HOG) algorithm.

6. The system of claim 1, wherein the analysis server is configured to determine whether there is a need for pedestrian caution based on traffic signal information, and whether there is a pedestrian at an intersection based on a direction of progress of a vehicle.

7. The system of claim 1, wherein the analysis server is configured to:
divide a time zone when vehicle traffic and pedestrian traffic conflict with each other based on the traffic signal information; and
determine whether there is a need for pedestrian caution based on whether there is a pedestrian in the image data collected in the divided time zone.

8. The system of claim 1, wherein the navigation server is configured to:
generate guidance information for providing guidance on vehicle behavior control for the pedestrian safety based on the analysis of the pedestrian safety; and
transmit the generated guidance information to the vehicle terminal.

9. The system of claim 1, wherein the navigation server is configured to:
generate a route for reaching a destination from a starting point depending on a route navigation request transmitted from the vehicle terminal;
obtain traffic signal information in the route; and
transmit the route in conjunction with the traffic signal information in the route to the vehicle terminal.

10. The system of claim 1, wherein the vehicle terminal is configured to transmit the pedestrian safety information to an output device.

11. A method for providing safety information, the method comprising:
receiving, by an analysis server, image data and traffic signal information from an external device;
recognizing, by the analysis server, a pedestrian from the image data;
analyzing, by the analysis server, pedestrian safety associated with the recognition of the pedestrian in view of the traffic signal information;
transmitting, by the analysis server, the analysis of the pedestrian safety to a navigation server; and
transmitting, by the navigation server, pedestrian safety information to a vehicle terminal based on the analysis of the pedestrian safety.

12. The method of claim 11, wherein receiving the image data and the traffic signal information includes:
transmitting, by the vehicle terminal, forward image data of a vehicle being obtained by a camera mounted on the vehicle, to the navigation server; and
receiving and transmitting, by the navigation server, the forward image data of the vehicle to the analysis server.

13. The method of claim 11, wherein receiving the image data and the traffic signal information includes:
receiving, by the analysis server, the image data obtained by an infrastructure installed on a roadside; and
receiving, by the analysis server, the traffic signal information from a traffic signal operating system.

14. The method of claim 11, wherein recognizing of the pedestrian includes:
determining, by the analysis server, whether there is a pedestrian in the image data using a pedestrian discrimination model.

15. The method of claim 14, wherein the pedestrian discrimination model is a histogram of oriented gradients (HOG) algorithm.

16. The method of claim 11, wherein analyzing pedestrian safety includes:
determining, by the analysis server, whether there is a need for pedestrian caution based on traffic signal information, and whether there is a pedestrian at an intersection based on a direction of progress of a vehicle.

17. The method of claim 11, wherein analyzing pedestrian safety includes:
dividing, by the analysis server, a time zone when vehicle traffic and pedestrian traffic conflict with each other based on the traffic signal information; and
determining, by the analysis server, whether there is a need for pedestrian caution based on whether there is a pedestrian in the image data collected in the divided time zone.

18. The method of claim 11, wherein transmitting the pedestrian safety information includes:
generating, by the navigation server, guidance information for providing guidance on vehicle behavior control for the pedestrian safety based on the analysis of the pedestrian safety; and
transmitting, by the navigation server, the generated guidance information to the vehicle terminal.

19. The method of claim 11, further comprising:
generating, by the navigation server, a route for reaching a destination from a starting point depending on a route navigation request transmitted from the vehicle terminal;
obtaining, by the navigation server, traffic signal information in the route; and
transmitting, by the navigation server, the route in conjunction with the traffic signal information in the route to the vehicle terminal.

20. The method of claim 11, further comprising:
outputting, by the vehicle terminal, the pedestrian safety information to an output device.
